(19) United States
(12) Patent Application Publication
(10) Pub. No.: US 2026/0006633 A1
(43) Pub. Date: Jan. 1, 2026

(54) RADIO RESOURCE MANAGEMENT SPLIT FOR RADIO POWER POOLING IN ACTIVE ANTENNA SYSTEM

(71) Applicant: Telefonaktiebolaget LM Ericsson (publ), Stockholm (SE)

(72) Inventor: Shiguang GUO, Kanata (CA)

(21) Appl. No.: 18/880,653

(22) PCT Filed: Jul. 6, 2022
(86) PCT No.: PCT/IB2022/056249

§ 371 Date: Jan. 2, 2025

(51) Int. Cl. H04W 72/566; H04W 52/36; H04W 72/12

(52) U.S. Cl. CPC H04W 72/566; H04W 52/367; H04W 72/12

(57) ABSTRACT

A Distributed Unit (DU) or vDU of a wireless network node operates to send, to an Antenna Integrated Radio (AIR) or ORAN Radio of the wireless network node, scheduling attributes associated with each one of a plurality of Scheduling Entities (SEs) among multiple carriers. The scheduling attributes include an indication of a priority of the associated SE and whether or not the associated SE can be dropped. The AIR receives the scheduling attributes and drops one or more low priority droppable SEs based on a total power requirement and a target power level of the AIR. The AIR sends, to the DU, information identifying the dropped SEs of the corresponding carriers and DU or vDU. The DU reschedules at least a subset of the dropped SEs for transmission in a subsequent transmission time interval (TTI).

### TECHNICAL FIELD

the present disclosure relates to radio resource management, and in particular to radio resource management split for radio power pooling in active antenna system.

### BACKGROUND

Active antenna system (AAS) is a key technology adopted by 4G LTE and 5G NR to enhance the wireless network performance and capacity by using Multiple-In-Multiple-Out (MIMO) techniques including Full Dimension Multiple-In-Multiple-Out (FD-MIMO) or massive MIMO.

In order to handle high signal processing demands, gNB devices are typically designed using a multi-core architecture known in the art. In view of this, a radio resource management (RRM) instance is typically designed to execute in a unique subset of cores, which are allocated to a single carrier. While this arrangement enables efficient execution of time-critical RRM functions for each carrier, it also makes RRM coordination among the different carriers very difficult to achieve. This is because the coordination will introduce dependency and increases the latency. This becomes even more problematic in cases of multiple radio access technologies (RATs), multiple frequency bands, and multiple carriers, which may be deployed across multiple devices. In such implementations, each RAT (such as LTE and NR) will likely have its own Software (SW) stack, which greatly complicates RRM coordination.

To realize multiplexing gain, at least some level of RRM coordination among different carriers without increasing latency would be highly desirable.

### SUMMARY

Aspects of the present invention provide methods and systems for radio resource management in massive MIMO radio.

Accordingly, an aspect of the present invention provides a method in an Antenna Integrated Radio (AIR) of a wireless network node. The method comprises: receiving, from one or more Distributed Units (DUs) of the wireless network node, scheduling attributes associated with each one of a plurality of Scheduling Entities (SEs), the scheduling attributes comprising an indication of a priority of the associated SE and whether or not the associated SE can be dropped; dropping one or more low priority droppable SEs based on a total power requirement and a target power level of the AIR; and sending, to the one or more DUs, information identifying the dropped SEs.

In some embodiments, receiving scheduling attributes comprising receiving, from each DU, a respective plurality of SEs and associated scheduling attributes.

In some embodiments, at least droppable SEs are sorted based on the priority indication to generate a sorted list of droppable SEs.

In some embodiments, dropping one or more low priority droppable SEs comprises: calculating the total power requirement based on time and frequency resources required to transmit at least a subset of the plurality of SEs; and dropping the one or more low priority droppable SEs such that the calculated total power requirement is less than or equal to the target power level.

In some embodiments, the target power level is a maximum transmission power level of the AIR during a transmission time interval (TTI) or a slot. In other embodiments, the maximum transmission power level is predetermined based on a transmission power capacity of the AIR. In yet other embodiments, the maximum transmission power level is predetermined based on maximum allowable effective radiated power (ERP) of the AIR.

In some embodiments, sending information identifying the dropped SEs comprises sending, to the one or more DUs, an identifier of each dropped SE. In other embodiments, sending information identifying the dropped SEs comprises sending, to each DU, an identifier of each dropped SE among the plurality of SEs received from that DU.

In some embodiments, the method further includes allocating radio resources for transmitting remaining SEs that were not dropped.

Another aspect of the present invention provides an Antenna Integrated Radio (AIR) of a wireless network node. The AIR comprises: at least one processor; and a non-transitory memory storing computer instructions configured to cause the at least one processor to: receive, from one or more Distributed Units (DUs) of the wireless network node, scheduling attributes associated with each one of a plurality of Scheduling Entities (SEs), the scheduling attributes comprising an indication of a priority of the associated SE and whether or not the associated SE can be dropped; drop one or more low priority droppable SEs based on a total power requirement and a target power level of the AIR; and send, to the one or more DUs, information identifying the dropped SEs.

In some embodiments, the computer instructions are further configured to cause the at least one processor to: calculate the total power requirement based on time and frequency resources required to transmit at least a subset of the plurality of SEs; and drop the one or more low priority droppable SEs such that the calculated total power requirement is less than or equal to the target power level.

In some embodiments, the target power level is a maximum transmission power level of the AIR during a transmission time interval (TTI) or a slot. In some embodiments, the maximum transmission power level is predetermined based on a transmission power capacity of the AIR. In other embodiments, the maximum transmission power level is predetermined based on maximum allowable effective radiated power (ERP) of the AIR.

In some embodiments the computer instructions are further configured to cause the at least one processor to allocate radio resources for transmitting remaining SEs that were not dropped.

Another aspect of the present invention provides a method operative in a Distributed Unit (DU) of a wireless network node. The method comprises steps of: sending, to an Antenna Integrated Radio (AIR) of the wireless network node, scheduling attributes associated with each one of a plurality of Scheduling Entities (SEs), the scheduling attributes comprising an indication of a priority of the associated SE and whether or not the associated SE can be dropped; receiving, from the AIR, information identifying one or more dropped SEs; and rescheduling, responsive to the information identifying one or more dropped SEs, at least a subset of the one or more dropped SEs for transmission in a subsequent transmission time interval.

In some embodiments, sending scheduling attributes comprises sending the scheduling attributes and the associated SE to the AIR.

Another aspect of the present invention provides a Distributed Unit (DU) of a wireless network node. The DU comprises: at least one processor; and a non-transitory memory storing computer instructions configured to cause the at least one processor to: send, to an Antenna Integrated Radio (AIR) of the wireless network node, scheduling attributes associated with each one of a plurality of Scheduling Entities (SEs), the scheduling attributes comprising an indication of a priority of the associated SE and whether or not the associated SE can be dropped; receive, from the AIR, information identifying one or more dropped SEs; and reschedule, responsive to the information identifying one or more dropped SEs, at least a subset of the one or more dropped SEs for transmission in a subsequent transmission time interval.

Embodiments of a base station, communication system, and a method in a communication system are also disclosed.

Embodiments of the techniques described herein may provide any one or more of the following benefits:
an indirect way is provided to implement RRM coordination among carriers based on AAS's requirements such as power in PA which is shared among carriers. This technique is considered to be indirect, in that it does not require direct communication and coordination between RRM instances operating in the DU(s);
The same or different RAT (such as NR or LTE) may be used within any given carrier.
Statistical multiplexing gain of multiple carriers and mixed mode (NR and LTE) can be obtained. This allows a lower power PA design meeting the same traffic demand. This provides a significant opportunity to reduce cost and energy consumption of AAS while meeting the same capacity.
QOS requirements and traffic demands of each carrier can be met.
It does not affect the time-critical loop of RRM scheduling processes and maintains the radio performance.
The method is computationally efficient, and so may be implemented in both in a gNB for downlink (DL) traffic and in a user equipment (UE) for transmitting uplink (UL) traffic.
The same methods can be applied to 3GPP and ORAN compliant radio systems.

### BRIEF DESCRIPTION OF THE DRAWINGS

The accompanying drawing figures incorporated in and forming a part of this specification illustrate several aspects of the disclosure, and together with the description serve to explain principles of the disclosure.

FIG. 1 is a block diagram schematically illustrating elements of an antenna array;

FIG. 2 is a block diagram schematically illustrating elements of a wireless network node;

FIG. 3 is a block diagram schematically illustrating signal processing a wireless network node;

FIGS. 4A and 4B illustrate statistical multiplexing gain in an example system of comprising three carriers;

FIG. 5 is a block diagram schematically illustrating signal processing in a wireless network node;

FIG. 6 is a flow-chart illustrating steps in a process according to embodiments of the present disclosure;

FIG. 7 is a flow-chart illustrating steps in a further process according to embodiments of the present disclosure;

FIG. 8 is a block diagram schematically illustrating signal processing in a wireless network node according to embodiments of the present disclosure;

FIG. 9 is a flow-chart illustrating steps in a process according to embodiments of the present disclosure; and

FIG. 10 schematically illustrates consolidation of SEs from multiple carriers into a single sorted list of droppable SEs according to embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

At least some of the following abbreviations and terms may be used in this disclosure.
2D Two Dimensional
3GPP Third Generation Partnership Project
5G Fifth Generation
AAS Antenna Array System
AIR Antenna integrated radio
AoA Angle of Arrival
AoD Angle of Departure.
ASIC Application Specific Integrated Circuit
BF Beamforming
BLER Block Error Rate
BW Beamwidth
CPU Central Processing Unit
CSI Channel State Information
dB Decibel
DCI Downlink Control Information
DFT Discrete Fourier Transform
DSP Digital Signal Processor
eNB Enhanced or Evolved Node B
FIR Finite Impulse Response
FPGA Field Programmable Gate Array
gNB New Radio Base Station
ICC Information Carrying Capacity
IIR Infinite Impulse Response
LTE Long Term Evolution
MIMO Multiple Input Multiple Output
MME Mobility Management Entity
MMSE Minimum Mean Square Error.
MTC Machine Type Communication
NR New Radio
OTT Over-the-Top
PBCH Physical Broadcast Channel
PDCCH Physical Downlink Control Channel
PDSCH Physical Downlink Shared Channel
P-GW Packet Data Network Gateway
RAM Random Access Memory
ROM Read Only Memory
RRC Radio Resource Control
RRH Remote Radio Head
SCEF Service Capability Exposure Function
SINR Signal to Interference plus Noise Ratio
TBS Transmission Block Size
UE User Equipment
ULA Uniform Linear Array
URA Uniform Rectangular Array

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting (and/or receiving) signals to (and/or from) a radio access node. Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Cell: As used herein, a “cell” is a combination of radio resources (such as, for example, antenna port allocation, time and frequency) that a wireless device may use to exchange radio signals with a radio access node, which may be referred to as a host node or a serving node of the cell. However, it is important to note that beams may be used instead of cells, particularly with respect to 5G NR. As such, it should be appreciated that the techniques described herein are equally applicable to both cells and beams.

Note that references in this disclosure to various technical standards (such as 3GPP TS 38.211 V15.1.0 (2018-03) and 3GPP TS 38.214 V15.1.0 (2018-03), for example) should be understood to refer to the specific version(s) of such standard(s) that is (were) current at the time the present application was filed, and may also refer to applicable counterparts and successors of such versions.

The description herein focuses on a 3GPP cellular communications system and, as such, 3GPP terminology or terminology similar to 3GPP terminology is oftentimes used. However, the concepts disclosed herein are not limited to a 3GPP system. For example, techniques described in this disclosure may be applied to an Open-RAN (ORAN) network as defined in technical specifications published by the O-RAN Alliance.

Active antenna system (AAS) is a key technology adopted by 4G LTE and 5G NR to enhance the wireless network performance and capacity by using Multiple-In-Multiple-Out (MIMO) techniques including Full Dimension Multiple-In-Multiple-Out (FD-MIMO) or massive MIMO. FIG. 1 schematically illustrates an antenna array 100 of a type that is commonly used in an AAS. The illustrated arrangement, the antenna array 100 is configured as a two-dimensional array (with M rows and N columns) of antenna elements 102, each of which is configured to transmit and receive RF signals on K polarizations (K=2 in case of cross-polarization).

Codebook-based precoding in AAS is based on a set of pre-defined precoding matrices. The precoding matrix indication (PMI) may be selected by the UE with DL CSI-RS, or by eNB/gNB with UL reference signals.

The precoding matrix, denoted as W, may be further described as for example a two-stage precoding structure as follows:

$$W = {W}_{1} {W}_{2} .$$

The first stage, W₁, may be described as a codebook, and consists essentially a group of 2D grid-of-beams (GoB), which may be characterized as

$${W}_{1} = [ \begin{matrix}{w}_{h} ⊗ {w}_{v} & 0 \\ 0 & {w}_{h} ⊗ {w}_{v}\end{matrix} ]$$

where wₕ and wᵥ are precoding vectors selected from over-sampled DFT for horizontal direction and vertical direction, respectively, and may be expressed by

$${w}_{v} = {\frac{1}{\sqrt{M}} [ 1 , {e}^{\frac{j 2 π v}{{MO}_{1}}} , … , {e}^{\frac{j 2 π mv}{{MO}_{1}}} , … , {e}^{\frac{j 2 π ( M - 1 ) v}{{MO}_{1}}} ]}^{T}$$

$${w}_{h} = {\frac{1}{\sqrt{N}} [ 1 , {e}^{\frac{j 2 π h}{{NO}_{2}}} , … , {e}^{\frac{j 2 π nv}{{NO}_{2}}} , … , {e}^{\frac{j 2 π ( N - 1 ) h}{{NO}_{2}}} ]}^{T}$$

where O₁ and O₂ are the over-sampling rate in vertical and horizontal directions, respectively.

The second stage, W₂, is used for beam selection within the group of 2D GoB as well as the associated co-phasing between two polarizations.

In NR, W₁ is determined according to UE PMI report for index values (i1) in the horizontal direction. W₂ is determined according to UE PMI report for index values (i2) in the vertical direction. UE will feed back PMI to gNB. gNB will apply corresponding precoder for the transmission after receiving the UE feedback.

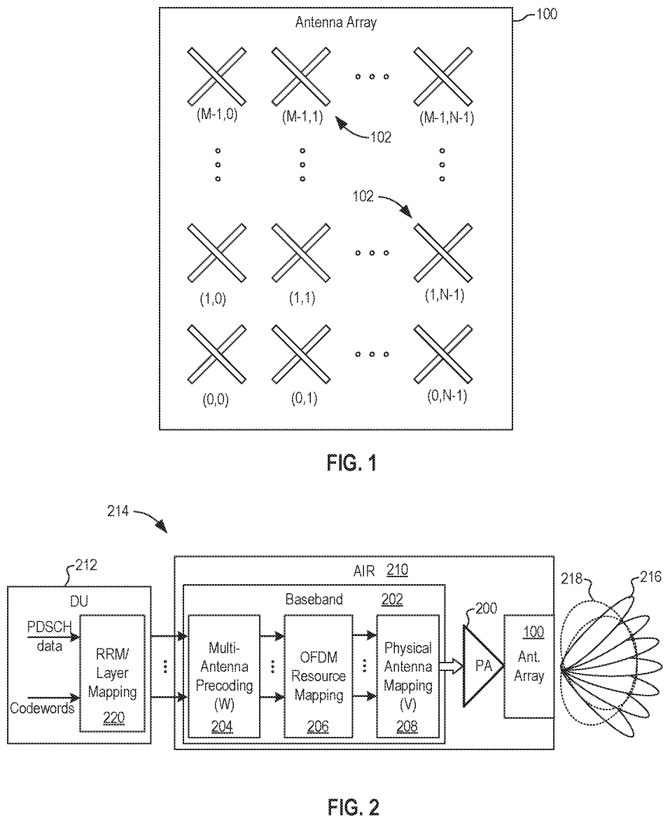

Referring to FIG. 2, an Advanced Antenna System (AAS) extends the functionality of a conventional Radio Unit (RU) by integrating an antenna array 100, analog radio signal processing 200 (such as power amplifier and analog filters), and baseband digital signal processing 202 (such as precoding (i.e. beamforming) 204, OFDM Resource mapping 206 and Physical antenna mapping 208) in a single device, which may be referred to as an Antenna Integrated Radio (AIR) 210. The AIR 210 may be connected to one or more Distributed Units (DUs) 212 to form a wireless network node 214 such as a gNB. Under the ORAN standards, an AIR 210 may also be referred to as an ORAN compliant radio unit (O-RU), and a DU 212 may be referred to as a virtualized DU (vDU).

AIR baseband functions such as beamforming 204 may be performed in AIR 210 on different channels/signals, such as PDSCH, CSI-RS, DM-RS, etc. By this means, some channels (such as PDSCH and DM-RS) may be mapped to relatively narrow beams 216, while other channels (such as CSI-RS) may be mapped to relatively wide beams 218.

The DU 212 typically provides radio resource management (RRM) 220 to handle radio traffic as will be described in greater detail below.

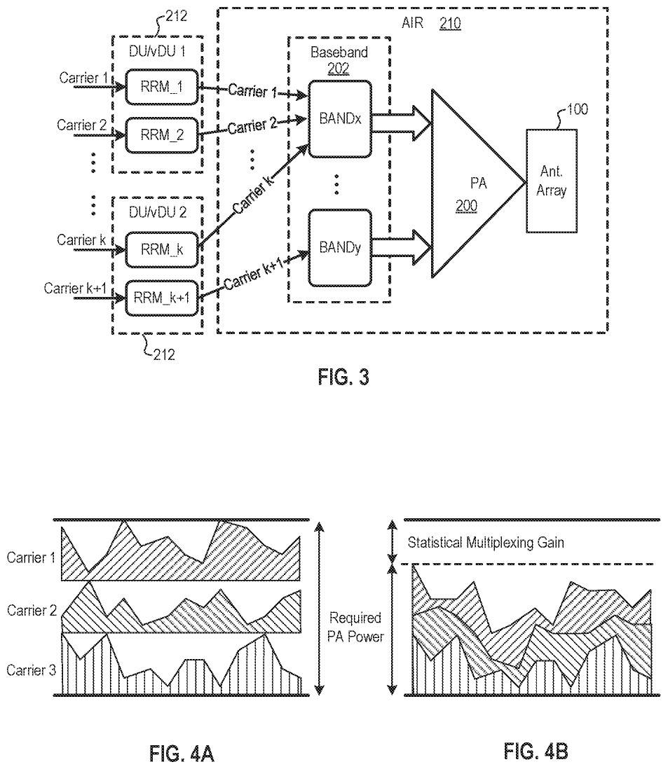

As may be seen in FIG. 3, to support more bandwidth, reduce building cost and facilitate deployment, an AIR 210 may support multiple carriers and bands with one or more DUs 212. Multiple Radio Access Technologies (RATs), such as LTE or NR, may also be supported in a mixed mode system. Analog radio path 200, such as a power amplifier (PA), and accompanying analog radio frequency filters (not shown) may be shared among the multiple carriers and RATs. One Analog radio path 200 is commonly used for each antenna polarization. The PA power capability should be chosen to support the traffic needs of all of the carriers. This means that the maximum power will assume the worst case traffic demand (corresponding to usage of 100% of time-frequency resources) of all carriers at the same time. PA power represents a big proportion of the unit cost of an AIR 200. In addition, the higher the PA power, the more cooling and energy consumption will be needed.

In a live network, the traffic pattern typically fluctuates over time on each carrier and will differ from one carrier to another. For example, FIG. 4A illustrates representative traffic patterns for three channels within an evaluation window that may correspond with a transmission slot. During the evaluation window, the traffic demand in each channel only occasionally reaches the full capacity of that channel. Consequently, and as may be seen in FIG. 4B, the actual total traffic demand across all three channels will be lower than the worst case traffic demand most of the time. The difference between the worst case traffic demand and the peak composite demand within the evaluation window is referred to as statistical multiplexing gain. This means that for the evaluation window, the maximum power needed by the PA 200 may be much lower than that required by the worst case demand.

Power pooling has been proposed as a means to achieve statistical multiplexing gain so that the PA can be under dimensioned, relative to the “worst case” demand scenario. This may provide opportunities to reduce cost, energy consumption, etc. However, power pooling requires the gNB to dynamically (e.g. on a per slot basis) schedule radio resources to each channel to respect a desired PA power target.

Radio Resource Management (RRM) is a network function implemented in the DU used to schedule radio resources (time and frequency) to handle traffic demand. The more radio resources are allocated, the higher PA power is expected. This is assuming a constant power spectrum density per bandwidth and duration.

RRM can support traffic with different QOS requirements, which are typically denoted in terms of latency and packet loss. Some traffic, such as web browsing, is delay-tolerant and will have fewer latency requirements. Other traffic such as Voice over Internet Protocol (VoIP) and video streaming are time-sensitive and thus will have strict latency requirements. RRM operates to try to schedule different traffic types with different QOS requirement as optimally as possible.

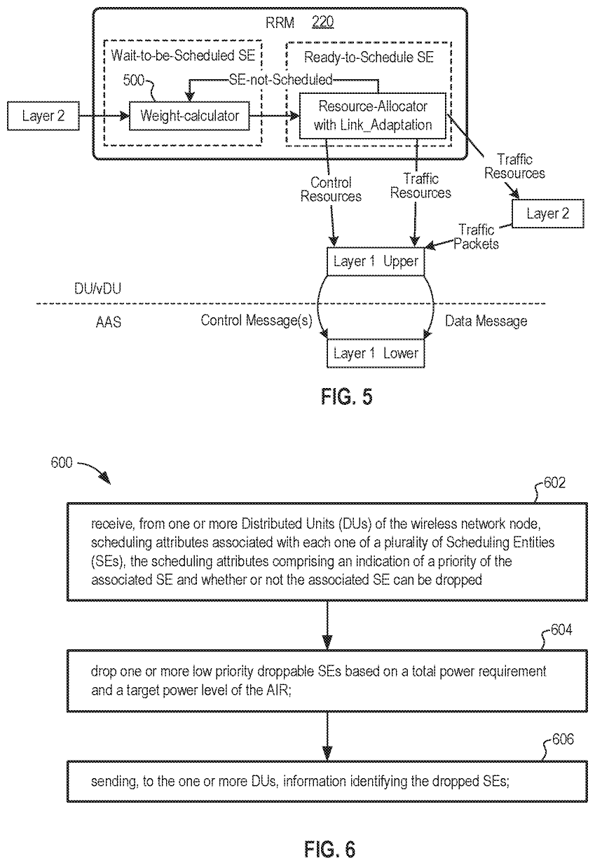

One RRM instance is typically provided for a single carrier. The resource allocation procedure for a carrier, also called scheduling, is done in multiple steps as shown in FIG. 5.

Step 1: An RRC connected UE will have opportunities to be scheduled as long as there is data in its packet data convergence protocol (PDCP) buffer. A UE-specific transmission that can be scheduled may be referred to as a scheduling entity (SE). Examples of an SE include, but are not limited to: a new UE-specific transmission; a retransmission due to previous link failure; a broadcast message; and a random access channel (RACH) transmission, such as a transmission before a UE is RRC connected when a UE tries to perform initial access to the network. A transmission associated with data in the applicable PDCP buffer may be referred to as a “Wait-to-be-scheduled SE”.

Step 2: Priority weights (which may be based on QOS) of all of the Wait-to-be-scheduled SEs may be continuously calculated, for example by a weight-calculator module 500. The weight for a given SE may increment over time depending on a selected scheduling policy. High priority SEs may be selected for transmission in a particular transmission time interval (TTI) or slot, and may be considered as “Ready-to-schedule SEs”.

Step 3: Ready-to-schedule SEs are allocated time/frequency radio resources (e.g. in Physical Downlink Shared Channel (PDSCH)), along with corresponding control resources (e.g. in Physical Downlink Control Channel (PDCCH)). Once the time/frequency radio resources and corresponding control resources have been allocated for a given SE, that SE may be considered as “Scheduled”. Due to limited radio resources, for example, at least some of the Ready-to-schedule SEs will not receive a resource allocation. Such SEs return to the “wait to be scheduled” state, and wait for the next scheduling opportunity.

Step 4: For each scheduled SE, the associated scheduling decisions (e.g. allocated time/frequency radio resources) are sent to User Plane (UP) layer 2 and baseband 202 of the AIR 210, where the data packet(s) will be processed for transmission.

In order to handle high signal processing demands, gNB devices (such as DU and AIR) are typically designed using a multi-core architecture known in the art. In view of this, an RRM instance is typically designed to execute in a unique subset of cores, which are allocated to a single carrier. While this arrangement enables efficient execution of time-critical RRM functions for each carrier, it also makes RRM coordination among the different carriers very difficult to achieve. This is because the coordination will introduce dependency and increases the latency. This becomes even more problematic in cases of multiple RATs, multiple frequency bands, and multiple carriers, which may be deployed across multiple DUs. In such implementations, each RAT (such as LTE and NR) will likely have its own Software (SW) stack, which greatly complicates RRM coordination.

To realize multiplexing gain, at least some level of RRM coordination among different carriers without increasing latency would be highly desirable. Increased latency leads to reduced capacity. For example, it would be desirable to coordinate radio resource allocations for different carriers in the time domain, to avoid the coincidence of peak usage events. However, since traffic demand in each carrier is unpredictable and the scheduling process is in a time critical loop with different QOS requirements, it is very hard to coordinate resource allocations in the time domain among different carriers without increasing latency.

When carriers are allocated among different DUs 212, this becomes even more difficult due to additional latency required for communication between different physical equipment. Therefore, a radio centric coordination scheme among multiple carriers is needed since the radio is shared among carriers.

Systems and methods are disclosed herein that provide efficient dynamic power pooling. Embodiments of the invention may be implemented in a wireless access node such as a gNB, for example, implemented as one or more Distributed Units (DUs) connected to an Antenna Integrated Radio (AIR) unit, both of which may comply with 3GPP standards. For convenience, example embodiments of the invention will be described using terminology that relates primarily to these embodiments. However, it will be appreciated that the present invention is not limited to 3GPP compliant gNB systems. For example, techniques in accordance with the present invention may be implemented in a wireless access node composed of one or more virtualized Distributed Units (vDUs) connected to virtualized Radio Unit (vRU), both of which may comply with Open RAN (O-RAN) standards.

Referring to FIG. 6, a method (600) implemented in an Antenna Integrated Radio (AIR) of a wireless network node may include:
receiving (602), from one or more Distributed Units (DUs) of the wireless network node, scheduling attributes associated with each one of a plurality of Scheduling Entities (SEs). The scheduling attributes may comprise an indication of a priority of the associated SE and whether or not the associated SE can be dropped;
Dropping (604) one or more low priority droppable SEs based on a total power requirement and a target power level of the AIR; and
sending (606), to the one or more DUs, information identifying the dropped SEs.

In some embodiments, receiving scheduling attributes comprising receiving, from each DU, a respective plurality of SEs and associated scheduling attributes.

In some embodiments, at least droppable SEs are sorted based on the priority indication to generate a sorted list of droppable SEs.

In some embodiments, dropping one or more low priority droppable SEs comprises: calculating the total power requirement based on time and frequency resources required to transmit at least a subset of the plurality of SEs; and dropping the one or more low priority droppable SEs such that the calculated total power requirement is less than or equal to the target power level.

In some embodiments, the target power level is a maximum transmission power level of the AIR during a transmission time interval. In other embodiments, the maximum transmission power level is predetermined based on a transmission power capacity of the AIR. In yet other embodiments, the maximum transmission power level is predetermined based on maximum allowable effective radiated power (ERP) of the AIR.

In some embodiments, sending information identifying the dropped SEs comprises sending, to the one or more DUs, an identifier of each dropped SE. In other embodiments, sending information identifying the dropped SEs comprises sending, to each DU, an identifier of each dropped SE among the plurality of SEs received from that DU.

In some embodiments, the method further includes allocating radio resources for transmitting remaining SEs that were not dropped.

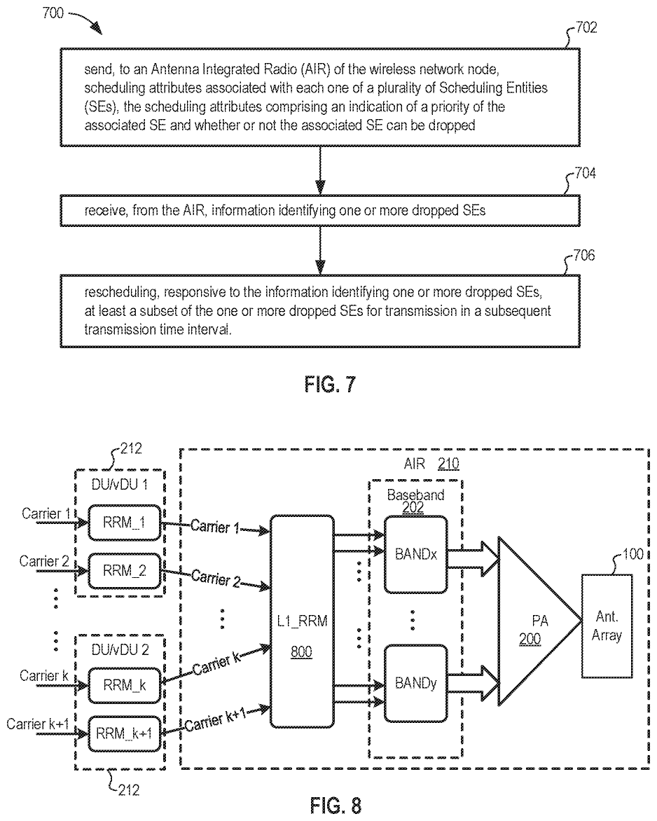

Referring to FIG. 7, a method (700) operative in a Distributed Unit (DU) of a wireless network node may comprise steps of:
sending (702), to an Antenna Integrated Radio (AIR) of the wireless network node, scheduling attributes associated with each one of a plurality of Scheduling Entities (SEs), the scheduling attributes comprising an indication of a priority of the associated SE and whether or not the associated SE can be dropped;
receiving (704), from the AIR, information identifying one or more dropped SEs; and
rescheduling (706), responsive to the information identifying one or more dropped SEs, at least a subset of the one or more dropped SEs for transmission in a subsequent transmission time interval.

In some embodiments, sending scheduling attributes comprises sending the scheduling attributes and the associated SE to the AIR.

If desired, the operations described above with reference to FIG. 6, may be implemented by means of a layer 1 Radio Resource Management (RRM) function executing in the AIR unit. For example, FIG. 8 illustrates an embodiment in which a plurality of RRM instances (RRM_1 . . . . RRM_k+1) executing in a pair of DUs 212 support a corresponding plurality of carriers. Each RRM instance may send SEs and associated scheduling attributes, on its respective carrier, to the AIR 210. All of the SEs and associated scheduling attributes may be received by a Layer_1 RRM instance (or module) 800 executing in the AIR 210, which performs the operations described above with reference to FIG. 6.

Correspondingly, the operations described above with reference to FIG. 7 may be implemented by suitably modifying the conventional Radio Resource Management (RRM) instances (e.g. RRM_1 . . . . RRM_k+1) executing in each DU 212. For example, conventional Radio Resource Management (RRM) instances may be modified such that, in addition to sending SEs and scheduling decisions to the AIR 210 (in accordance with, for example, 3GPP and/or O-RAN standards), associated scheduling attributes indicating SE priority and whether or not the associated SE may be dropped is also provided. In some embodiments, the scheduling attributes may be sent to the AIR 210 using an enhanced Common Public Radio Interface (eCPRI) user plane control message.

If desired, the scheduling attributes may be included in a scheduling decision message that includes other scheduling information known in the art. In some embodiments, the indication of SE priority may be provided as a bit-field having a length of, for example, two or three bits. The indication of whether the SE is droppable can be provided as a flag having a single bit. In such embodiments, the scheduling attributes may represent an addition of four bits (e.g 3 bits priority field and 1 bit droppable flag) to the conventional scheduling decision message. In some embodiments, the modified scheduling decision message may be formatted as an enhanced Common Public Radio Interface (eCPRI) user plane control message.

In some embodiments, SEs which relate to retransmissions, RRC messages, latency sensitive traffic, etc, may be indicated as non-droppable, and thus assigned a droppable flag value of ‘0’, for example. Conversely, latency insensitive traffic may be indicated as droppable, and thus assigned a droppable flag value of ‘1’, for example.

The Layer_1 Radio Resource Management (L1_RRM) module 800 operates to support dynamic power pooling in the PA 200 that is shared among multiple carriers. For example, the L1_RRM module 800 may consolidate the SE scheduling information for all SEs from all carriers.

For a given slot, the total resources needed to transmit at least a subset of the SEs are calculated. If the calculated total resources needed exceeds a predetermined target power level (which may also be referred to as a power budget), one or more lower priority droppable SEs are dropped so that the total resource needed will be less than or equal to the target power level. If desired, SEs can be sorted by their respective weights to facilitate identification (and dropping) of the lowest priority droppable SEs, in order to minimize undesired impacts on network performance or Quality of Experience (QoE). Finally, a notification identifying any SEs that have been dropped is provided to each DU 212 so that the dropped SEs can be scheduled again in a subsequent slot. Any data packets in layer 1 and layer 2 associated with the dropped SEs should be discarded.

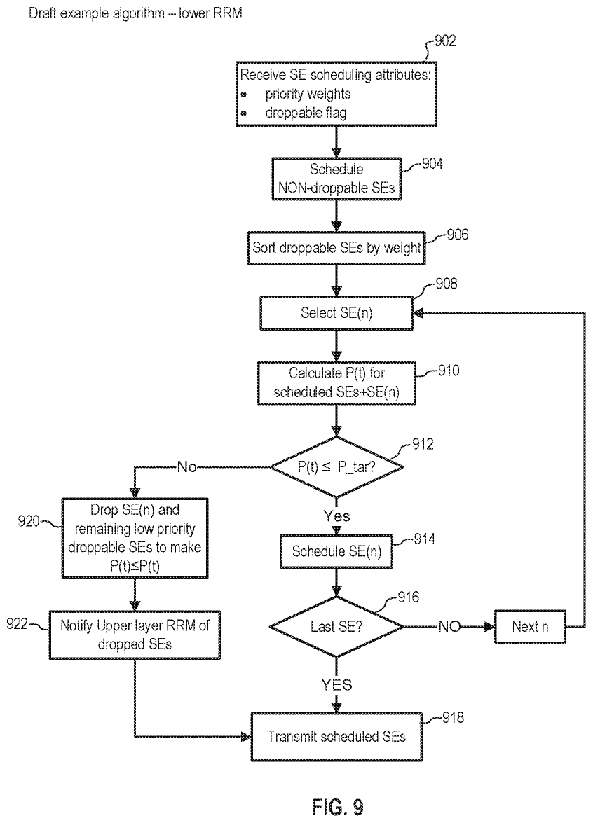

FIG. 9 is a flow-chart illustrating an example process implemented in the L1_RRM module 800 executing in a processor of the AIR 210.
Step 1 (902): the L1_RRM instance 800 receives scheduling attributes for each one of a plurality of SEs. As noted above, scheduling attributes may be received from multiple RRM instances (RRM_1 . . . . RRM_k+1) executing on multiple DUs 212. Commonly, each RRM instance (RRM_1 . . . . RRM_k+1) is associated with a respective carrier.
Step 2 (904): SEs that are indicated as being non-droppable (eg. have a droppable flag value=‘0’) are scheduled for transmission. In some embodiments, this implies that the non-droppable SEs are passed directly to baseband 202 for buffering and transmission. Alternatively, the non-droppable SEs are merely added to a “scheduled” list, so that the actual baseband processing and transmission will be performed later.
Step 3 (906): SEs that are indicated as being droppable (eg. have a droppable flag value=‘1’) are sorted according to their respective priority weight.

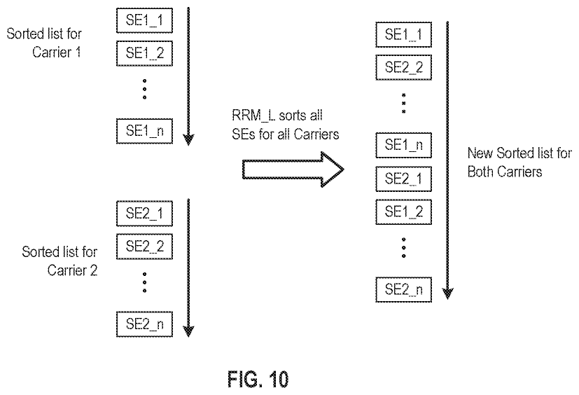

Consequently, droppable SEs from all carriers (across all DUs 212) are consolidated into a single sorted list of droppable SEs, as may be seen in the example of FIG. 10.
Step 4 (908): a droppable SE (n) (e.g. a droppable SE having a highest priority weight) is selected from the sorted list of droppable SEs.
Step 5 (910): the total resources (e.g. power level) P (t) needed to transmit both the scheduled SEs and the selected droppable SE (n), is calculated.
Step 6 (912): the calculated total resources P (t) is compared to the target maximum power level (i.e. power budget) P_tar.
Step 7 (914): If, at step 6 (912), the calculated total resources P (t) is less than or equal to the power budget P_tar, then the selected droppable SE (n) is scheduled for transmission. In some embodiments, this implies that the selected droppable SE (n) is passed directly to baseband 202 for buffering and transmission. Alternatively, the selected droppable SE (n) is added to the “scheduled” list, so that the baseband processing and transmission will be performed later.
Step 8 (916): If the selected (now scheduled) droppable SE (n) is the last SE in the sorted list of droppable SEs, then processing continues at Step 9 (918). Otherwise, processing continues at Step 4 (908) where a next droppable SE (n) is selected from the sorted list of droppable SEs.
Step 9 (918): Scheduled SEs are transmitted. In some embodiments, this operation will occur automatically as non-droppable SEs and then droppable SEs are scheduled as described above. Alternatively, the SEs identified in the “scheduled” list are passed to the baseband 202 for buffering and transmission. If desired, radio resources may be reallocated to the scheduled SEs to maximize the benefit of statistical multiplexing.
Step 10 (920): If, at step 6 (912), the calculated total resources P (t) is greater than the power budget P_tar, then the selected droppable SE (n) and any remaining (i.e. unscheduled) droppable SEs are dropped, in order to ensure that the calculated total resources P (t) remains less than or equal to the power budget P_tar.
Step 11 (922): instances (RRM_1 . . . . RRM_k+1) executing on the DUs 212 are notified of the dropped SEs. In some embodiments, this operation may be accomplished by forwarding the sorted list of droppable SEs to each of the DUs 212. Alternatively, each DU 212 may be provided an identification of only the dropped SEs that were forwarded to the L1_RRM instance 800 from that DU. Finally, operation will continue at step 9 (at 918), where the scheduled SEs are transmitted as described above.

While processes in the figures may show a particular order of operations performed by certain embodiments of the present disclosure, it should be understood that such order is representative, and that alternative embodiments may perform the operations in a different order, combine certain operations, overlap certain operations, etc.

Those skilled in the art will recognize improvements and modifications to the embodiments of the present disclosure. All such improvements and modifications are considered within the scope of the concepts disclosed herein.

1. A method operative in an Antenna Integrated Radio (AIR) of a wireless network node, the method comprising:
receiving, from one or more carriers in one or more Distributed Units (DUs) of the wireless network node, scheduling attributes associated with each one of a plurality of Scheduling Entities (SEs), the scheduling attributes comprising an indication of a priority of the associated SE and whether or not the associated SE can be dropped;
dropping one or more low priority droppable SEs based on a total power requirement and a target power level of the AIR, dropping one or more low priority droppable SEs comprising:
calculating the total power requirement based on time and frequency resources required to transmit at least a subset of the plurality of SEs; and
dropping the one or more low priority droppable SEs such that the calculated total power requirement is less than or equal to the target power level; and
sending, to the one or more DUs, information identifying the dropped SEs.

2. The method of claim 1, wherein receiving scheduling attributes comprising receiving, from each DU, a respective plurality of SEs and associated scheduling attributes.

3. The method of claim 1, further comprising sorting at least droppable SEs based on the priority indication to generate a sorted list of droppable SEs.

4. (canceled)

5. The method of claim 1, wherein the target power level is a maximum transmission power level of the AIR during a transmission time interval.

6. The method of claim 5, wherein the maximum transmission power level is predetermined based on a transmission power capacity of the AIR.

7. The method of claim 5, wherein the maximum transmission power level is predetermined based on maximum allowable effective radiated power (ERP) of the AIR.

8. The method of claim 1, wherein sending information identifying the dropped SEs comprises sending, to the one or more DUs, an identifier of each dropped SE.

9. The method of claim 1, wherein sending information identifying the dropped SEs comprises sending, to each DU, an identifier of each dropped SE among the plurality of SEs received from that DU.

10. The method of claim 1, further comprising allocating radio resources for transmitting remaining SEs that were not dropped.

11. An Antenna Integrated Radio (AIR) of a wireless network node, the AIR comprising:
at least one processor;
a non-transitory memory storing computer instructions configured to cause the at least one processor to:
receive, from one or more Distributed Units (DUs) of the wireless network node, scheduling attributes associated with each one of a plurality of Scheduling Entities (SEs), the scheduling attributes comprising an indication of a priority of the associated SE and whether or not the associated SE can be dropped;
drop one or more low priority droppable SEs based on a total power requirement and a target power level of the AIR, the computer instructions being further configured to cause the at least one processor to:
calculate the total power requirement based on time and frequency resources required to transmit at least a subset of the plurality of SEs; and
drop the one or more low priority droppable SEs such that the calculated total power requirement is less than or equal to the target power level; and
send, to the one or more DUs, information identifying the dropped SEs.

12. The AIR of claim 11, wherein the computer instructions are further configured to cause the at least one processor to sort at least droppable SEs based on the priority indication to generate a sorted list of droppable SEs.

13. (canceled)

14. The AIR of claim 11, wherein the target power level is a maximum transmission power level of the AIR during a transmission time interval.

15. The AIR of claim 14, wherein the maximum transmission power level is predetermined based on a transmission power capacity of the AIR.

16. The AIR of claim 14, wherein the maximum transmission power level is predetermined based on maximum allowable effective radiated power (ERP) of the AIR.

17. The method of claim 11, wherein the computer instructions are further configured to cause the at least one processor to allocate radio resources for transmitting remaining SEs that were not dropped.

18.-20. (canceled)

21. The method of claim 2, further comprising sorting at least droppable SEs based on the priority indication to generate a sorted list of droppable SEs.

22. The method of claim 21, further comprising allocating radio resources for transmitting remaining SEs that were not dropped.

23. The method of claim 2, further comprising allocating radio resources for transmitting remaining SEs that were not dropped.

24. The method of claim 3, further comprising allocating radio resources for transmitting remaining SEs that were not dropped.

25. The method of claim 5, further comprising allocating radio resources for transmitting remaining SEs that were not dropped.
